(19) United States
(12) Patent Application Publication
(10) Pub. No.: US 2014/0189602 A1
(43) Pub. Date: Jul. 3, 2014

(54) METHOD AND ASSOCIATED SYSTEM FOR DISPLAYING GRAPHIC CONTENT ON EXTENSION SCREEN

(71) Applicant: MEDIATEK INC., Hsin-Chu (TW)

(72) Inventors: Tsung-Te Wang, Taipei City (TW); Hui-Wen Wang, Taipei (TW); Shiau-Wei Chiou, Taipei City (TW); Hsin-Hsiung Chiu, Taichung City (TW); Wei-Ting Hsieh, Tainan City (TW)

(73) Assignee: MEDIATEK INC., Hsin-Chu (TW)

(21) Appl. No.: 13/729,088

(22) Filed: Dec. 28, 2012

(51) Int. Cl. G06F 3/01

(52) U.S. Cl. CPC G06F 3/017
USPC 715/863

(57) ABSTRACT

A method for displaying graphic content on an extension screen, comprising: when a detected user activity at a host screen is matched to one of a plurality of gestures, providing a gesture icon in response to the matched gesture; and providing a shared content according to an original content, such that a combined content, which is a combination of the shared content and the gesture icon, can be displayed on the extension screen. An associated system is also disclosed.

### FIELD OF THE INVENTION

The present invention relates to a method and associated system for displaying graphic content on extension screen, and more particularly, to a method and associated system capable of showing indicative gesture icons on extension screen in response to user activity detected at host screen.

### BACKGROUND OF THE INVENTION

Handheld/portable devices, such as mobile phones, personal digital assistants (PDA), notebook/pad computers, navigators, digital cameras/camcorders, game consoles and portable media players etc., are popular and broadly adopted. Modern portable device may include touch screen which functions to sense user activities (e.g., touches of single finger or multiple fingers and/or hand writing) and to display graphic content.

While portable device is convenient to be carried by user, its touch screen may suffer from constrained dimensions which offer only limited area to display graphic contents, e.g., images, videos and/or graphic user interface. To address the issue, modern portable device is capable of transmitting contents to an extension screen like another portable device, a television, a monitor, a projector, etc.; with the touch screen of portable device and the extension screen, the overall area for displaying graphic content is hence expanded.

An important scenario to utilize extension screen is mirroring contents of the touch screen to the extension screen, so user can view scaled mirrored content shown on the extension screen. For example, a user can connect to websites by executing a browser application in a portable device, and the contents of the browser application generated by accessing websites can be mirrored and transmitted to a larger extension screen, so the user can enjoy better visual presentation of the contents of the browser application. A user can also play multi-media contents by executing a player application in a portable device which cooperates with an extension screen, thus contents provided (e.g., decoded and/or rendered) by the player application can be shown not only on the touch screen of the portable device but also on the extension screen.

However, as the user needs to maintain control of the content-providing application by interacting with the touch screen, the user has to frequently divert his/her line of sight from the extension screen to the touch screen. Content viewing/browsing experience is therefore interrupted and degraded.

### SUMMARY OF THE INVENTION

Therefore, the present invention relates to a method and an associated system for enhancing user experience without compromise controlling of the content-providing application.

An objective of the invention is providing a method for displaying graphic content (including images, video and/or graphic interface) on an extension screen. The extension screen can be an extension of a host screen (e.g., a touch screen). The method includes: when a detected user activity at a host screen is matched to one of a plurality of gestures, providing a gesture icon in response to the matched gesture, and providing a shared content according to an original content (e.g., mirroring the original content to provide the shared content), such that a combined content, which is a combination of the gesture icon and the shared content, can be displayed on the extension screen. By displaying the gesture icon on the extension screen in response to user activity detected at the host screen or a sensor pad integrated with the host screen, a user can directly obtain visual clues of his/her own control activity on the extension screen, thus the user can maintain control of the content-providing application without losing sight of the extension screen. In an embodiment, when the extension screen displays the combined content, the host screen can display the original content, any other content or even no content, as long as the touch-sensing function of the host screen remains working. For example, the host screen can be left to display no content, e.g., the host screen can be set to display a blank picture, an animated screen saver, a default image (wallpaper) and/or a help instruction to remind user that the extension screen is in use instead of the host screen.

In an embodiment, the method also includes: associating each of the gestures with a drawing style such that there are two of the gestures being associated with different drawing styles; while providing the gesture icon, providing the gesture icon according to the drawing style associated with the matched gesture. That is, different gestures can be associated with different gesture icons of different drawing styles, e.g., different icon shapes, and/or different colors, etc. In an embodiment, while the shared content and the gesture icon are combined to form the combined content, the gesture icon can be overlaid on the shared content at a location corresponding to a location of the detected user activity, such that a geometric relation between the location of the detected user activity and the host screen is also mirrored to a geometric relation between the location of the gesture icon and the extension screen.

In an embodiment, when the detected user activity is matched to one of the plurality of gestures, a gesture message, indicating which one of the gestures is matched, is provided. The gesture message is received, such that the gesture icon can be provided according to the gesture message. While the original content is provided according to execution of an application, the gesture message is also sent to the application, so the application can be controlled in response to the gesture message.

In an embodiment, different modes of displaying on the extension screen are supported. An extension screen mode flag is registered to indicate which mode is selected, such that one of the combined content and the shared content is selectively displayed on the extension screen according to which value the extension screen mode flag equals. That is, in one of the modes selected by configuring the extension screen mode flag with a first predetermined value, the combined content is displayed on the extension screen with gesture icons overlaid; in another mode selected by setting the extension screen mode flag equal to a second predetermined value, the shared content is displayed on the extension screen with no gesture icon shown, or no content is displayed on the extension screen. In another embodiment, by configuring the extension screen mode flag with a first predetermined value, the combined content is displayed on the extension screen with gesture icons overlaid; in another mode selected by setting the extension screen mode flag equal to a second predetermined value, the shared content is displayed on the extension screen with no gesture icon shown; and If the extension screen mode flag equals a third predetermined value, no content, e.g., a default blank picture, is displayed on the extension screen.

In an embodiment, the detected user activity is sensed when user physically touches a sensor pad and/or when user is in proximity of a sensor pad. Different gestures icons can be selectively provided in response to whether a contact activity or a proximity activity is sensed. That is, different gestures icons (e.g., a proximity gesture icon and a contact gesture icon) and/or different drawing styles can be provided respectively in response to a first gesture (a proximity gesture) and a second gesture (a contact gesture), wherein the first gesture is matched if the detected user activity is sensed when user is in proximity of a sensor pad, and the second gesture is matched if the detected user activity is sensed when user touches the sensor pad. While a user approaches the sensor pad to physically touch it, the proximity gesture icon can serve as a preview to show where the touch gesture icon will locate, such that the user can know whether his/her touch will hit a desired target location, e.g., a location of a virtual button for controlling the content-providing application. In an embodiment, the sensor pad and the host screen are integrated into a touch screen.

An objective of the invention is providing a system for displaying graphic content on an extension screen by implementing aforementioned method of the invention. The system includes a gesture icon module and a content module. When a detected user activity at a host screen is matched to one of a plurality of gestures, the gesture icon module is capable of providing a gesture icon in response to the matched gesture. The content module is capable of providing a shared content according to an original content, such that a combined content, which is a combination of the gesture icon and the shared content, is displayed on the extension screen.

In an embodiment, the system also includes a gesture icon library capable of associating each of the gestures with a drawing style such that there are two of the gestures being associated with different drawing styles, and the gesture icon module is capable of providing the gesture icon according to the drawing style associated with the matched gesture.

In an embodiment, the system further includes a first port and a second port. The first port is capable of receiving a gesture message which indicates the matched gesture, the gesture icon module is capable of providing the gesture icon in response to the gesture message, and the content module is further capable of providing the original content according to execution of an application. The second port is capable of sending the gesture message to the application.

In an embodiment, the system further includes a register capable of registering an extension screen mode flag, such that the extension screen selectively displays the combined content, the shared content or displays no content according to which value the extension screen flag equals.

In an embodiment, the gesture icon module is further capable of providing different gestures icons and/or drawing styles respectively for a contact gesture and a proximity gesture.

In an embodiment, the system further includes a combining module capable of combining the shared content and the gesture icon to provide the combined content. The gesture icon module, the content module and the combining module are integrated into a processor of the host screen. In another embodiment, the content module is included in a processor of the host screen; the gesture icon module and the combining module are integrated into a controller of the extension screen.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 illustrates a flow according to an embodiment of the invention;

FIG. 2 illustrates execution of the flow shown in FIG. 1 according to an embodiment of the invention;

FIG. 3 illustrates association between gestures and their gesture icons/drawing styles according to an embodiment of the invention; and

FIG. 4 illustrates a system according to an embodiment of the invention.

### DETAILED DESCRIPTION OF PREFERRED EMBODIMENTS

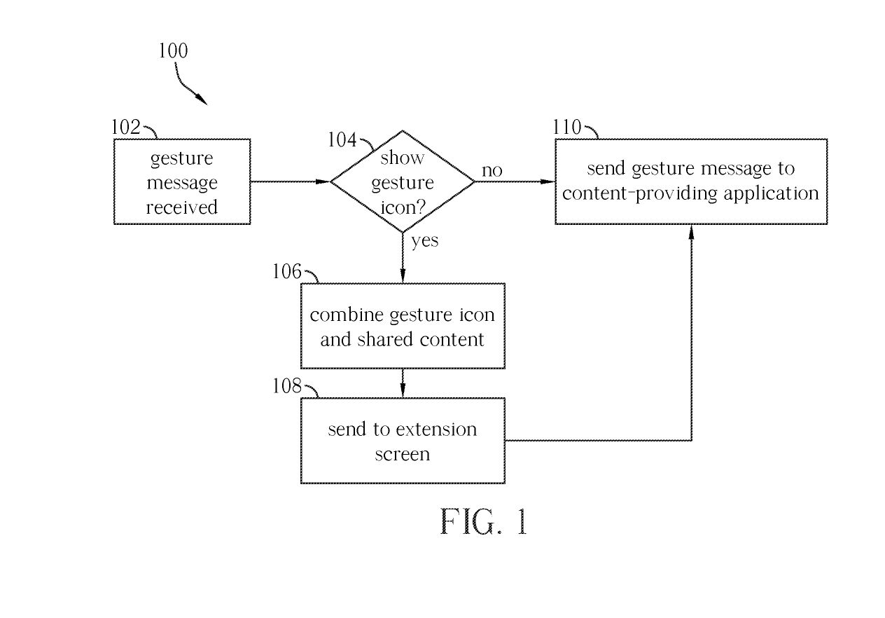

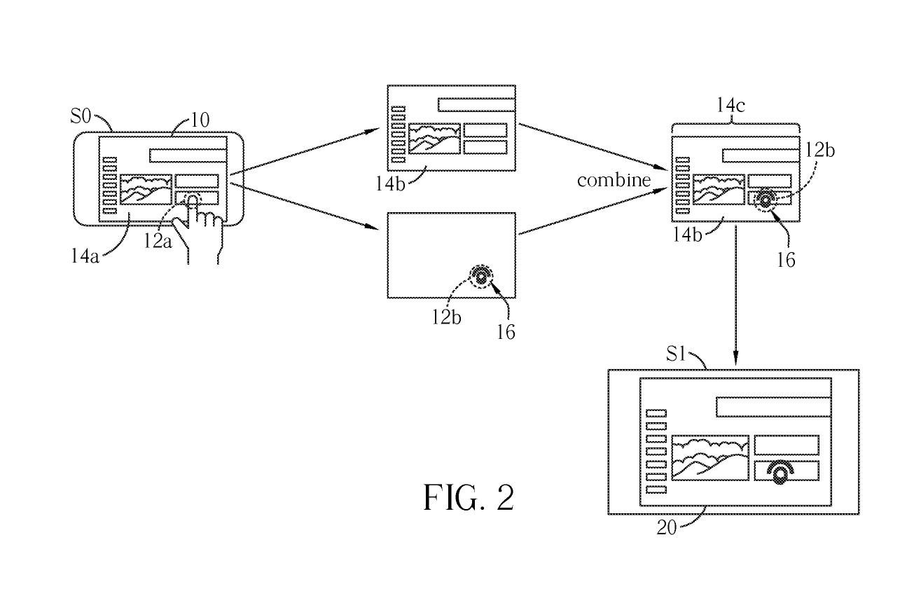

Please refer to FIG. 1 and FIG. 2; FIG. 1 illustrates a flow 100 according to an embodiment of the invention, and FIG. 2 illustrates execution of the flow 100 according to an embodiment of the invention. In an embodiment, the flow 100 is utilized to display graphic content on an extension screen 20 of an extension device 51 (FIG. 2), which can be an extension of a host screen 10 of a portable device S0. In general, the host screen 10 can be larger or smaller than the extension screen 20; the host screen 10 and the extension screen 20 can also be of the same dimensions. In an embodiment, the host screen 10 is integrated with a touch pad or sensor pad capable of detecting user activities. The flow 100 can include the following steps.

Step 102: when a user activity is detected by the touch pad or sensor pad, a driver interfacing the touch pad or sensor pad is capable of generating a corresponding sensor signal to indicate behavior of the detected activity, such as location(s), movements, strokes and/or duration of the activity. According to the sensor signal, the detected user activity can be matched to one of a plurality of predefined gestures, and an associated gesture message, for indicating which one (or ones) of the gestures is (are) matched, can be generated. By receiving the gesture message, the flow 100 starts.

Step 104: in an embodiment, different modes of displaying on the extension screen 20 are supported. An extension screen mode flag can be registered to indicate which mode is selected. If the extension screen mode flag equals a first predetermined value, the flow 100 can proceed to step 106; if the extension screen mode flag equals a second predetermined value, the flow 100 can proceed to step 110, or alternatively, the extension screen 20 can be set to display no content; for example, the extension screen 20 can display a blank picture, an animated screen saver, a default image (wallpaper) and/or a help instruction to remind user that there are other modes to display graphic content on the extension screen 20. In another embodiment, if the extension screen mode flag equals a first predetermined value, the flow 100 can proceed to step 106; if the extension screen mode flag equals a second predetermined value, the flow 100 can proceed to step 110; if the extension screen mode flag equals a third predetermined value, the extension screen 20 can be left to display no content. The extension screen mode flag can be configured according to selection of user. It should be noted that registering an extension screen mode flag is illustrative only, any other way capable of indicating modes of displaying on the extension screen 20 is within scope of the invention.

Step 106: according to an original content 14a of the host screen 10 (FIG. 2), a shared content 14b for the extension screen 20 can be provided. In addition, a gesture icon 16 can be provided according to the gesture message. Hence, the shared content 14b and the gesture icon 16 can be combined to provide a combined content 14c (FIG. 2) for the extension screen 20. In an embodiment, the original content 14a can be provided by execution of a content-providing application, and can be mirrored (e.g., scaled) to provide the shared content 14b. In another embodiment, a portion of the original content 14a can be extracted to form the shared content 14b or to be included as a portion of the shared content 14b. Alternatively, the original content 14a can be included as a portion of the shared content 14b.

The shared content 14b and the gesture icon 16 can be combined by the device S0 containing the host screen 10, and then the resultant combined content 14c is sent to the extension device S1 containing the extension screen 20 for display. Alternatively, the shared content 14b can be generated by the device S0 and sent to the extension device S1, combination and displaying of the shared content 14b and the gesture icon 16 can both be executed by the extension device S1.

In an embodiment of step 106, while combining the shared content 14b and the gesture icon 16 to provide the combined content 14c, the gesture icon 16 can be overlaid on the shared content 14b at a location 12b (FIG. 2) corresponding to a location 12a of the detected user activity, such that a geometric relation between the location 12a and the original content 14a/the host screen 10 can also be mirrored to a geometric relation between the location 12b of the gesture icon 16 and the shared content 14b/the combined content 14c/the extension screen 20.

Step 108: send the combined content 14c to the extension screen 20, such that the combined content 14c can be displayed on the extension screen 20. On the other hand, if the flow 100 diverts to step 110 after step 104, other content instead of the combined content 14c can be sent to the extension screen 20 for display; for example, the shared content 14b without the gesture icon 16 can be sent to the extension screen 20 for display. In a further embodiment, there can be no content sent to the extension screen 20 if the flow 100 diverts to step 110 after step 104.

In an embodiment, when the extension screen 20 displays the combined content 14c, the host screen 10 displays the original content 14a. In another embodiment, when the extension screen 20 displays the combined content 14c, the host screen 10 displays no content; for example, the host screen 10 can be set to display a blank picture, an animated screen saver, a default image (wallpaper) and/or a help instruction to remind user that the extension screen is in use instead of the host screen.

Step 110: send the gesture message to the content-providing application, such that the application can respond to the gesture message.

For the extension screen display mode supported by steps 106 and 108, the gesture icon 16 can be displayed on the extension screen 20 in response to user activity detected at the host screen 10 or a sensor pad integrated with the host screen 10, so a user can directly obtain visual clues of his/her own control activity on the extension screen 20, and can thus maintain control of the content-providing application without diverting sight of the extension screen 20. Content viewing experience is therefore improved and upgraded. In an embodiment, gesture icons are not shown on the host screen 10.

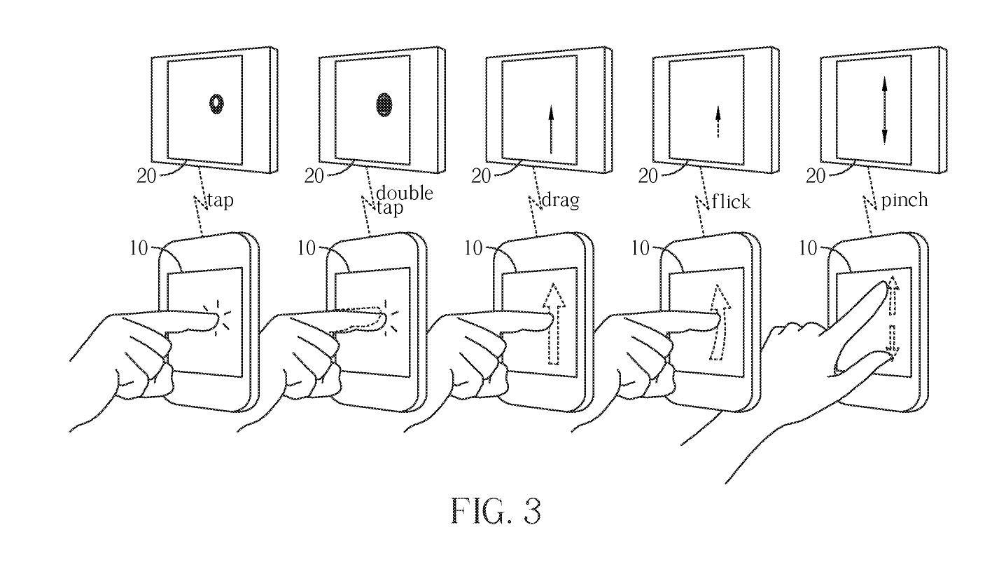

Please refer to FIG. 3 illustrating association of gestures and gesture icons according to an embodiment of the invention. As shown in FIG. 3, different gestures can be associated with different gesture icons; for example, gestures of tapping, double tapping, dragging, flicking and pinching detected at the host screen 10 or a sensor pad integrated with the host screen 10 can be respectively indicated by different gesture icons on the extension screen 20. The different gesture icons can be distinguished by their drawing styles, such as their shapes, colors, transparency, sizes, line types and/or line widths, etc.

For example, gestures involving point contact, such as tapping and double tapping, can be demonstrated by different point-shaped gesture icons centered at contact locations. In other embodiments, some kinds of gestures are formed when user moves touch point(s), such as dragging, flicking and/or pinching. For gestures involving movement of touch points, lines of different line types (e.g., solid-line, dashed-line, etc.), line widths, transparency, and/or line colors can be adopted as associated gesture icons. The line can start and end at locations associated with where a gesture movement starts and ends. In addition, directional hints can be added to the line to show direction of the gesture movement. For example, an arrow head can be attached to tail of a dragging track to demonstrate direction of the dragging gesture, and two arrow heads of opposite directions can be attached to two ends of a stroke between two touch points to represent the pinching gesture. And/or, a directional gesture icon can be demonstrated by a line of less width (and/or lighter color/transparency) at beginning and greater width (and/or darker color/transparency) at end of dragging.

Furthermore, text and/or symbol can be also included as an element of a gesture icon. For example, if a pinching gesture is interpreted as a zooming command by the content-providing application, a text of a numerical zoom factor and/or a plus sign (symbol) “+” can be included in the associated gesture icon.

For a gesture involving moving touch points such as dragging and pinching, rather than showing the gesture by a serial of discrete point-shaped icons (e.g., icons of tapping) scattered along the track of movement, linear and smooth trajectories fitting the track of movement can be adopted as associated gesture icon in the invention. Because user can barely obtain useful information (e.g., direction of movement and/or which gesture the user activity is interpreted as) from the scattered identical icons, the graphic user interface of the invention can improve user experience by highly informative gesture icons.

In an embodiment, the sensor pad integrated with the host screen 10 not only detects physical touch of user, but also detects proximity events of user. As proximity and physical contact can be detected as two kinds of gestures, they can be associated with different gesture icons of different drawing styles. For example, when a user approaches the sensor pad and then physically tap it, a proximity gesture icon and a different tapping gesture icon can be respectively shown when proximity and physical tapping are detected. The proximity gesture icon can serve as a preview to show where the user will touch, such that the user can know whether his/her touch can hit a desired target location, e.g., a location of a virtual button for controlling the content-providing application or a hyperlink for accessing a website. In an embodiment, proximity gesture icons can be derived from associated gesture icons of physical contact. For example, a proximity gesture icon indicating proximity of a tapping can has the same shape as the gesture icon of a physical tapping, but with a lighter color and/or dimmer transparency.

While mapping user activity detected at the host screen 10 or a sensor pad integrated with the host screen 10 to associated gesture icon shown on the extension screen 20, an error-protection mechanism can be included to help user to adapt the mapping. For example, proximity gestures can function as a portion of the error-protection mechanism, since user can preview whether a target location can be hit by observing the proximity gestures. And/or, the error-protection mechanism can include: defining one or more gestures as preview gestures in addition to controlling gestures which actually control the content-providing application. For example, a tapping lasting shorter than a predetermined interval can be recognized as a preview gesture, and can be demonstrated by a preview gesture icon, such that a user can preview location of tapping; the content-providing application does not have to respond to the preview gesture, or the content-providing application can respond by graphically indicating a closest location for receiving control, e.g., a virtual button or hyperlink closet to location of the preview gesture. On the other hand, a tapping longer than the predetermined interval can be interpreted as an actual tapping gesture for tapping the content-providing application, and can be demonstrated by a gesture icon different from the preview gesture icon.

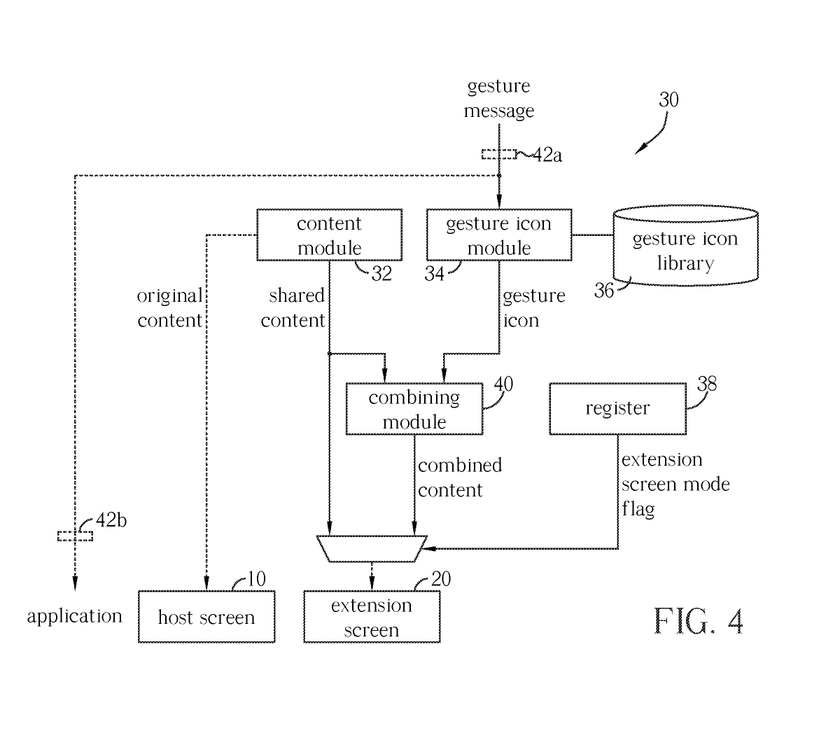

Please refer to FIG. 4 illustrating a system 30 according to an embodiment of the invention. The system 30 is capable of displaying graphic content on an extension screen 20 by implementing the flow 100 of the invention. The system 30 can include a content module 32, a gesture icon module 34, a gesture icon library 36, a register 38 and a combining module 40.

When a user activity is detected (e.g., by a sensor pad integrated with the host screen 10) and is matched to one of plural predetermined gesture by, for example, gesture recognition software and/or hardware, a gesture message which indicates the matched gesture can be provided. Via a port 42a of the system 30, the gesture message can be received. In response to the gesture message, the gesture icon module 34 is capable of providing an associated gesture icon. The gesture icon library 36 is capable of associating each of the predetermined gestures with a drawing style such that at least two of the gestures can be associated with different drawing styles, and the gesture icon provided by the gesture icon module 34 can be rendered according to the drawing style associated with the matched gesture. Via a port 42b of the system 30, the gesture message can be sent to a content-providing application.

The content module 32 is capable of providing the original content according to execution of the content-providing application, also capable of providing a shared content according to the original content if the extension screen 20 is used. The combining module 40 is capable of combining the shared content and the gesture icon to provide a combined content, such that the combined content can be displayed on the extension screen 20 if an extension screen mode flag registered by the register 38 equals a first predetermined value. Instead, the shared content can be sent to the extension screen 20 to be displayed, or no content is displayed on the extension screen 20, if the extension screen mode flag equals a second predetermined value. In another embodiment, the combined content can be displayed on the extension screen 20 if an extension screen mode flag registered by the register 38 equals a first predetermined value, the shared content can be sent to the extension screen 20 to be displayed on the extension screen 20 if the extension screen mode flag equals a second predetermined value, and the extension screen 20 can display no content if the extension screen mode flag equals a third predetermined value.

In an embodiment, the sensor pad integrated with the host screen 10 is capable of detecting user proximity and physical touch/contact; accordingly, the gesture icon module 34 is further capable of providing different gestures icons and/or drawing styles respectively for a proximity gesture and a contact gesture. In an embodiment, the sensor pad is a sensor capable of detecting multi-touch, such as a capacitive touch sensor or any other sensor capable of detecting multi-touch.

In an embodiment, besides built-in default drawing styles, drawing styles stored in the gesture icon library 36 can be customized by user. The modules and elements of the system 30 can be respectively implemented by software, firmware and/or hardware. In an embodiment, the system 30 is implemented as a software (or firmware) framework interfacing between an operating system of a portable device and applications installed under the operating system.

In an embodiment, the content module 32, the gesture icon module 34, the gesture icon library 36, the combining module 40 and the register 38 can be integrated into a processor of the host screen 10; the processor and the host screen 10 can be included in a portable device, and the extension screen 20 can be provided by a separate/remote monitor, projector, television and/or another portable device. The combined content (or the shared content) can be sent to the extension screen by direct (point-to-point or ad hoc) or routed communication of wired and/or wireless interconnection. And/or, the extension screen 20 can be another screen integrated with the portable device. For example, the portable device can have two screens, or a screen and a projecting element, respectively as the host screen 10 and the extension screen 20.

In another embodiment, the host screen 10 and the extension screen 20 can respectively belong to two separate devices; while the content module 32 can be included in a processor of the host screen 10 of the first device, the gesture icon module 34, the gesture icon library 36, the register 38 and the combining module 40 can be integrated into a controller of the extension screen 20 of the second device. While FIG. 1 to FIG. 4 illustrate some exemplary embodiments of the invention, numerous alternative embodiments can be employed to implement the invention. For example, the processor of the host screen 10 can include more or fewer modules of the system 30 while the controller of the extension screen 20 complementarily includes remaining modules. Also, there are different configurations for implementation of the host screen 10 and the extension screen 20, as well as various ways to transmit/interchange contents between the host screen 10 and the extension screen 20.

To sum up, the invention provides a better solution for displaying graphic content on extension screen; by showing highly informative gesture icons on the extension screen to indicate user activities at the host screen or a sensor pad integrated with the host screen, user can maintain control via the host screen without frequently diverting sight of the extension screen, and user experience is therefore improved and enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for displaying graphic content on an extension screen, comprising:
when a detected user activity at a host screen is matched to one of a plurality of gestures, providing a gesture icon in response to the matched gesture; and
providing a shared content according to an original content, such that a combined content, which is a combination of the gesture icon and the shared content, is displayed on the extension screen.

2. The method of claim 1 further comprising:
associating each of the gestures with a drawing style such that there are two of the gestures being associated with different drawing styles; and
while providing the gesture icon, providing the gesture icon according to the drawing style associated with the matched gesture.

3. The method of claim 1 further comprising:
receiving a gesture message which indicates the matched gesture; and
while providing the gesture icon, providing the gesture icon according to the gesture message;
providing the original content according to execution of an application; and
sending the gesture message to the application.

4. The method of claim 1 further comprising:
registering an extension screen mode flag, such that the combined content is displayed on the extension screen if the extension screen mode flag equals a first predetermined value, and the shared content or no content is displayed on the extension screen if the extension screen mode flag equals a second predetermined value.

5. The method of claim 1 further comprising:
while providing the shared content, mirroring the original content to provide the shared content.

6. The method of claim 1, wherein the detected user activity is sensed when user touches a sensor pad.

7. The method of claim 1, wherein the detected user activity is sensed when user is in proximity of a sensor pad.

8. The method of claim 1 further comprising:
providing different gestures icons respectively in response to a first gesture and a second gesture, wherein the first gesture is matched if the detected user activity is sensed when user is in proximity of a sensor pad, and the second gesture is matched if the detected user activity is sensed when user touches the sensor pad.

9. The method of claim 8, wherein the sensor pad and the host screen are integrated into a touch screen.

10. A system for displaying graphic content on an extension screen, comprising:
a gesture icon module, wherein when a detected user activity at a host screen is matched to one of a plurality of gestures, the gesture icon module is capable of providing a gesture icon in response to the matched gesture; and
a content module capable of providing a shared content according to an original content, such that a combined content, which is a combination of the gesture icon and the shared content, is displayed on the extension screen.

11. The system of claim 10 further comprising:
a gesture icon library capable of associating each of the gestures with a drawing style such that there are two of the gestures being associated with different drawing styles;
wherein the gesture icon module is capable of providing the gesture icon according to the drawing style associated with the matched gesture.

12. The system of claim 10 further comprising:
a first port capable of receiving a gesture message which indicates the matched gesture; and
a second port capable of sending the gesture message to an application;
wherein the gesture icon module is capable of providing the gesture icon in response to the gesture message, and the content module is further capable of providing the original content according to execution of the application.

13. The system of claim 10 further comprising:
a register capable of registering an extension screen mode flag, such that the extension screen selectively displays the combined content, the shared content and no content according to which value the extension screen flag equals.

14. The system of claim 10, wherein the content module is capable of mirroring the original content to provide the shared content.

15. The system of claim 10, wherein the detected user activity is sensed when user touches a sensor pad.

16. The system of claim 10, wherein the detected user activity is sensed when user is in proximity of a sensor pad.

17. The system of claim 10, wherein the gesture icon module is further capable of providing different gestures icons respectively in response to a first gesture and a second gesture; wherein the first gesture is matched if the detected user activity is sensed when user is in proximity of a sensor pad, and the second gesture is matched if the detected user activity is sensed when user touches the sensor pad.

18. The system of claim 17, wherein the sensor pad and the host screen are integrated into a touch screen.

19. The system of claim 10, further comprising a combining module capable of combining the shared content and the gesture icon to provide the combined content, wherein the gesture icon module, the content module and the combining module are integrated into a processor of the host screen.

20. The system of claim 10, further comprising a combining module capable of combining the shared content and the gesture icon to provide the combined content, wherein the content module is included in a processor of the host screen; the gesture icon module and the combining module are integrated into a controller of the extension screen.
